(19) United States
(12) Patent Application Publication
(10) Pub. No.: US 2025/0226467 A1
(43) Pub. Date: Jul. 10, 2025

(54) BATTERY PACK

(71) Applicant: SAMSUNG SDI CO., LTD., Yongin-si (KR)

(72) Inventors: Uihyeon JEONG, Yongin-si (KR); Youngmin LEE, Yongin-si (KR)

(21) Appl. No.: 18/612,393

(22) Filed: Mar. 21, 2024

(30) Foreign Application Priority Data
Jan. 4, 2024 (KR) 10-2024-0001745

(51) Int. Cl. H01M 10/48; H01M 10/42; H04B 10/112

(52) U.S. Cl. CPC H01M 10/482; H01M 10/425; H04B 10/1123; H01M 2010/4271; H01M 2010/4278

(57) ABSTRACT

A battery pack may be provided. The battery pack may include battery modules arranged along rows and columns, slave battery management systems (BMSs) respectively between adjacent ones of the battery modules in the rows of the battery modules, configured to detect status information of the adjacent ones of the battery modules, and at different respective heights, and a master BMS configured to receive status information of the battery modules through wireless optical communication with the slave BMSs.

### CROSS-REFERENCE TO RELATED APPLICATION

The present application claims priority to and the benefit of Korean Patent Application No. 10-2024-0001745, filed on Jan. 4, 2024, in the Korean Intellectual Property Office, the entire disclosure of which is incorporated herein by reference.

### BACKGROUND

### 1. Field

This disclosure relates to a battery pack.

### 2. Description of the Related Art

/A battery management system (BMS) may vary depending on a capacity or application of a battery pack, and may include a master BMS and a slave BMS.

The master BMS may collect measurement data of the battery module from the slave BMS, and may perform status estimation of the battery module, life prediction of the battery module, and fault diagnosis of the battery module based on the collected data. For this purpose, data communication technology between the master BMS and slave BMS is desired.

A wired communication between the master BMS and slave BMS may cause communication wiring defects, and there may be a risk of electrical short circuits due to external impact and vibration. Further, communication wiring may be assembled by workers, which may increase lead time.

A radio frequency (RF) wireless communication between the master BMS and the slave BMS may be vulnerable to security, and the cost of RF integrated circuit may be high due to the complex manufacturing process of the RF integrated circuit.

### SUMMARY

At least one of the embodiments may provide a battery pack that can improve at least one disadvantage of wired communication or wireless communication between a master BMS and a slave BMS.

According to one or more embodiments, a battery pack may be provided. The battery pack may include battery modules arranged along rows and columns, slave battery management systems (BMSs) respectively between adjacent ones of the battery modules in the rows of the battery modules, configured to detect status information of the adjacent ones of the battery modules, and at different respective heights, and a master BMS configured to receive status information of the battery modules through wireless optical communication with the slave BMSs.

The slave BMSs and the master BMS may each include an optical transmitter configured to transmit a wireless optical signal, and an optical receiver configured to receive a wireless optical signal.

The optical transmitters may be at different respective heights from a reference plane, wherein the optical receivers are at different respective heights from the reference plane.

The slave BMSs may be at different respective heights with respect to uppermost or lowermost surfaces of the battery modules.

The battery pack may further include a reflector configured to reflect a wireless optical signal from the optical transmitter of the slave BMSs to the optical receiver of the master BMS, and from the optical transmitter of the master BMS to the optical receiver of the slave BMSs.

The slave BMSs may further include a first analog front end integrated circuit (AFE IC) configured to measure status information of one of the adjacent ones of the battery modules, and a second AFE IC configured to measure status information of the other one of the adjacent ones of the battery modules.

The slave BMSs may be respectively fixed to side surfaces of the adjacent ones of the battery modules facing others of the adjacent ones of the battery modules.

The battery pack may further include a flexible printed circuit board (FPCB) connecting one of the slave BMSs to a corresponding one of the adjacent ones of the battery modules.

The wireless optical communication may use an infrared transmission medium.

A battery pack according to one or more other embodiments may include battery modules arranged along rows and columns such that there are pairs of battery modules respectively in the rows, slave battery management systems (BMSs) respectively on side surfaces of ones of the battery modules of the pairs of battery modules, the side surfaces facing others of the battery modules of the pairs of battery modules, ones of the slave BMSs in a same one of the columns being at different respective heights, and a Master BMS configured to communicate with the slave BMSs.

The slave BMSs and the master BMS may include an optical transmitter configured to transmit a wireless optical signal, and an optical receiver configured to receive a wireless optical signal.

The slave BMSs may further include a first analog front end integrated circuit (AFE IC) configured to measure status information of a first one of one of the pairs of the battery modules, and a second AFE IC configured to measure status information of a second one of the one of the pairs of the battery modules.

The slave BMSs and the master BMS may be configured to communicate using an infrared transmission medium.

The battery pack may further include a flexible printed circuit board (FPCB) connecting one of the slave BMSs and a corresponding one of the pairs of the battery modules.

The battery pack may further include a reflector configured to reflect a wireless optical signal from the slave BMSs to the master BMS, and configured to reflect a wireless optical signal from the master BMS to the slave BMSs.

### BRIEF DESCRIPTION OF THE DRAWINGS

FIG. 1 is a diagram showing an example of a battery pack according to one or more embodiments.

FIG. 2 is a diagram showing an example of the battery module shown in FIG. 1.

FIG. 3 is a schematic plan view of a battery pack to explain the position of a slave BMS according to one or more embodiments.

FIG. 4 is a diagram showing a slave BMS located between two battery modules.

FIG. 5 is a diagram showing the master BMS shown in FIG. 3.

FIG. 6 is a diagram illustrating an example of the spatial position of a slave BMS in a battery pack according to one or more embodiments.

FIG. 7 is a diagram showing another example of the spatial position of a slave BMS.

FIG. 8 is a diagram illustrating another example of the spatial position of a slave BMS in a battery pack according to one or more embodiments.

FIG. 9 is a schematic plan view of a battery pack to explain the position of a slave BMS according to one or more other embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure. The present disclosure covers all modifications, equivalents, and replacements within the idea and technical scope of the present disclosure. Further, each of the features of the various embodiments of the present disclosure may be combined with each other, in part or in whole, and technically various interlocking and driving are possible. Each embodiment may be implemented independently of each other or may be implemented together in an association.

In the drawings, the relative sizes of elements, layers, and regions may be exaggerated for clarity and/or descriptive purposes. Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

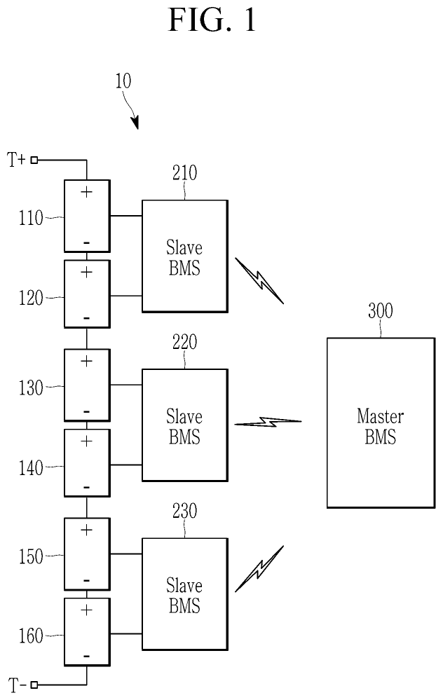

FIG. 1 is a diagram showing an example of a battery pack according to one or more embodiments.

Referring to FIG. 1, the battery pack 10 may include a plurality of battery modules 110, 120, 130, 140, 150, and 160, a plurality of slave battery management systems (BMS) 210, 220, and 230, and a master BMS 300. For convenience of explanation, FIG. 1 shows six battery modules 110, 120, 130, 140, 150, and 160.

The plurality of battery modules 110, 120, 130, 140, 150, and 160 may be connected to each other in series and/or parallel. The plurality of battery modules 110, 120, 130, 140, 150, and 160 may be connected to a charging device or to a load through system terminals T+ and T−, and may be charged by the charging device or discharged by the load. The plurality of battery modules 110, 120, 130, 140, 150, and 160 may each include a plurality of battery cells electrically connected in series and/or parallel.

Each of the plurality of slave BMSs 210, 220, and 230 may correspond to at least one battery module of battery modules 110, 120, 130, 140, 150, or 160. Each of the plurality of slave BMSs 210, 220, and 230 may be electrically connected to the corresponding battery module among the battery modules 110, 120, 130, 140, 150, and 160.

According to one or more embodiments, each slave BMS 210, 220, and 230 may correspond to two battery modules. For example, one slave BMS may control two battery modules. For example, the slave BMS 210 may be electrically connected to the battery modules 110 and 120, the slave BMS 220 may be electrically connected to the battery modules 130 and 140, and the slave BMS 230 may be electrically connected to the battery modules 150 and 160.

Each of the plurality of slave BMS 210, 220, and 230 may detect the overall status of the electrically connected battery modules, and may perform various control functions to adjust the state of the battery modules 110, 120, 130, 140, 150, and 160. The status may include cell voltages, module voltages, module currents and temperature, etc. Control functions may include charging, discharging, balancing, etc. The control function(s) may be performed directly by the slave BMS 210, 220, and 230 based on the status of the battery module 110, 120, 130, 140, 150, and 160, or may be performed according to commands from the master BMS 300. For example, the slave BMS 210 may be electrically connected to the two battery modules 110 and 120, and may perform control functions to adjust the states of the two battery modules 110 and 120.

The master BMS 300 may perform wireless optical communication with a plurality of slave BMSs 210, 220, and 230. The wireless optical communications may include infrared communications. The master BMS 300 receives status information of the battery modules 110, 120, 130, 140, 150, and 160 from the plurality of slave BMSs 210, 220, and 230 through wireless optical communication. The master BMS 300 may perform control functions, such as state of charge (SOC), power control, cell balancing control, fault diagnosis control, cooling control, and/or thermal runaway detection based on the received status information. In one or more embodiments, the master BMS 300 may control a relay for supplying or blocking power of the battery modules 110, 120, 130, 140, 150, and 160 to the load based on the status information of the battery modules 110, 120, 130, 140, 150, and 160.

Through wireless optical communication between the master BMS 300 and each of the plurality of slave BMS 210, 220, and 230, wiring complexity according to the wired communication method may be reduced, and security may be strengthened compared to RF wireless communication.

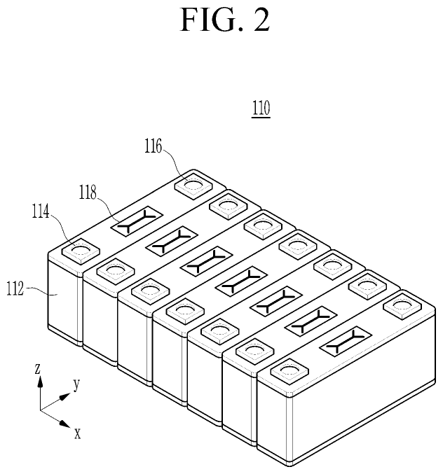

FIG. 2 is a diagram showing an example of the battery module shown in FIG. 1.

Referring to FIG. 2, the battery module 110 may include a plurality of battery cells 112 arranged in one direction. A battery cell 112 may accommodate an electrode assembly and an electrolyte inside a cell case forming a body thereof, and an opening 118 and electrode terminals 114 and 116 may be formed on the outer surface of the cell case.

The opening 118 may be configured to maintain a generally closed state, and may be configured to open if an event, such as thermal runaway of the battery cell 112, occurs, and if gas or flame is generated inside the battery cell 112, thereby emitting gas or flame to the outside of the battery cell 112. For example, the opening 118 may be provided by forming a notch in a corresponding part of the battery cell 112 so that the corresponding part ruptures if the internal pressure of the battery cell 112 sufficiently increases.

The battery cell 112 may be composed of a square cell. In one or more embodiments, the battery cell 112 may be composed of another type of cell (for example, a cylindrical cell), and the shape of the battery cell 112 may be not limited thereto.

The battery module 110 may be an assembly in which a plurality of battery cells 112 are combined into a single frame to increase the output power of the battery pack 100, and may protect against external impact or vibration.

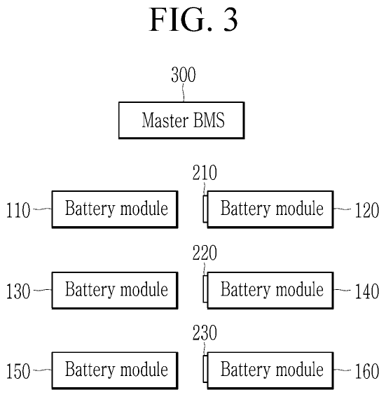

FIG. 3 is a schematic plan view of a battery pack to explain the position of a slave BMS according to one or more embodiments.

Referring to FIG. 3, a plurality of battery modules 110, 120, 130, 140, 150, and 160 may be located in a plurality of rows and a plurality of columns.

In one or more embodiments, two battery modules may be located in one row, and a slave BMS that manages the two battery modules may be located between the two battery modules located in one row.

For example, if the battery pack 100 includes six battery modules 110, 120, 130, 140, 150, and 160, the battery modules 110 and 120 may be located in the first row, and the slave BMS 210 may be located between the battery modules 110 and 120. The battery modules 130 and 140 may be located in the second row, and the slave BMS 220 may be located between the battery modules 130 and 140. In one or more embodiments, the battery modules 150 and 160 may be located in the third row, and the slave BMS 230 may be located between the battery modules 150 and 160.

In some embodiments, the slave BMS 210 may be combined to the side surface of any one battery module (e.g., battery module 120) of the battery modules 110 and 120. Similarly, the slave BMS 220 may be combined to the side surface of any one battery module (e.g., battery module 140) of the battery modules 130 and 140, and the slave BMS 230 may be combined to the side surface of any one battery module (e.g., battery module 160) of the battery modules 150 and 160.

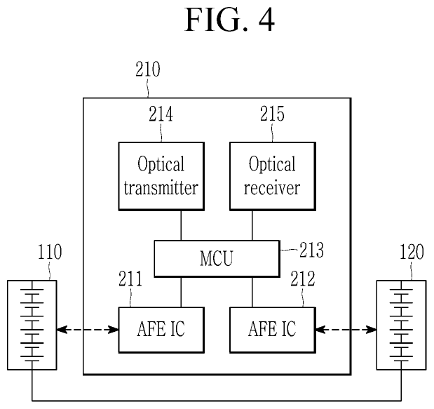

FIG. 4 is a diagram showing a slave BMS located between two battery modules.

Referring to FIG. 4, the slave BMS 210 may include analog front end (AFE) integrated circuits (ICs) 211 and 212, a microcontroller unit (MCU) 213, at least one optical transmitter 214, and at least one optical receiver 215. Although FIG. 4 shows the slave BMS 210 located between the battery modules 110 and 120, for convenience, the slave BMS 220 and 230 may also be configured the same or similar to the slave BMS 210.

Each of the AFE ICs 211 and 212 may be connected to each of the battery modules 110 and 120 through a flexible printed circuit board (FPCB).

The AFE IC 211 may measure physical state information, such as voltage, current, and/or temperature of the battery module 110, and may control charging and discharging of the battery module 110 and/or balancing of the battery module 110. The AFE IC 211 may transmit the measured status information of the battery module 110 to the MCU 213.

The AFE IC 212 may measure physical state information, such as voltage, current, and/or temperature of the battery module 120, and may control charging and discharging of the battery module 120 and/or balancing of the battery module 120. The AFE IC 212 may transmit the measured status information of the battery module 120 to the MCU 213.

The MCU 213 may control the operation of the AFE ICs 211 and 212. The MCU 213 may transmit status information of the battery modules 110 and 120, which may be transmitted from the AFE ICs 211 and 212, to the optical transmitter 214. In one or more embodiments, the MCU 213 may receive control signals of the master BMS 300 through the optical receiver 215, and may control or command the AFE ICs 211 and 212 according to the control signals of the master BMS 300. The MCU 213 may transmit the control signals of the master BMS 300 to the AFE ICs 211 and 212.

The optical transmitter 214 may perform signal processing on the status information of the battery modules 110 and 120, and may transmit the status information of the battery modules 110 and 120 through a wireless optical signal.

The optical receiver 215 may receive the control signals of the master BMS 300 through a wireless optical signal, may perform signal processing on the received control signals of the master BMS 300, and may transmit signal processed control signals to the MCU 213.

According to one or more embodiments, the optical transmitter 214 and the optical receiver 215 may transmit and receive signals using an infrared transmission medium.

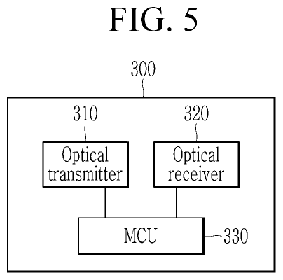

FIG. 5 is a diagram showing the master BMS shown in FIG. 3.

Referring to FIG. 5, the master BMS 300 may include an optical transmitter 310, an optical receiver 320, and an MCU 330.

The optical transmitter 310 may perform signal processing on the control signal of the master BMS 300, and may transmit the control signal of the master BMS 300 through a wireless optical signal. The optical receiver 320 may receive status information of the battery modules 110, 120, 130, 140, 150, and 160 through wireless optical signals, and may transmit the received status information of the battery modules 110, 120, 130, 140, 150, and 160 to the MCU 330.

The MCU 330 may diagnose and control the battery modules 110, 120, 130, 140, 150, and 160 based on the status information of the battery modules 110, 120, 130, 140, 150, and 160. The MCU 330 may generate control signals for controlling the battery modules 110, 120, 130, 140, 150, and 160, and may transmit the control signals to the optical receiver 320.

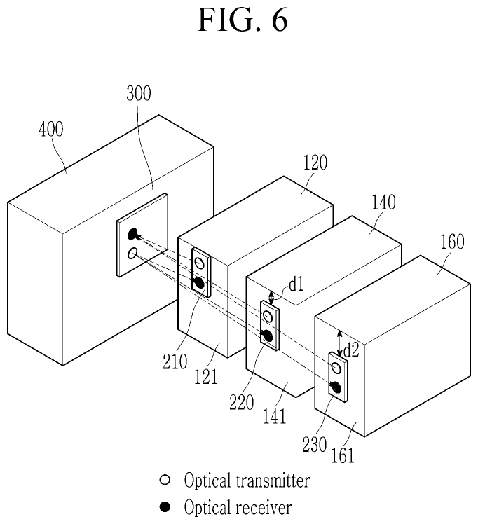

The optical transmitter 310 and the optical receiver 320 may transmit and receive signals using an infrared transmission medium. Such wireless optical communication may not transmit or receive signals if walls or obstacles exist. In one or more embodiments, the slave BMS 210, 220, and 230 may be located as shown in FIG. 6 so that there are no walls or obstacles between the master BMS 300 and each slave BMS 210, 220, and 230 for transmitting and receiving signals.

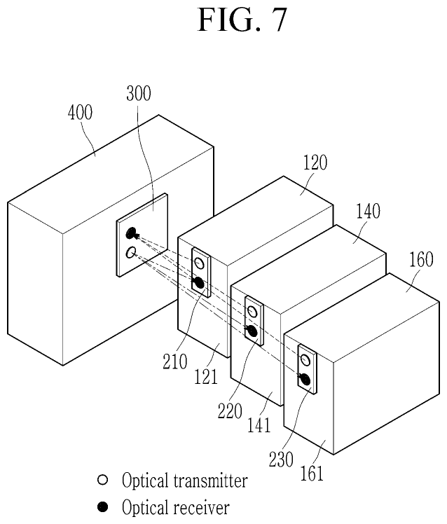

FIG. 6 is a diagram illustrating an example of the spatial position of a slave BMS in a battery pack according to one or more embodiments, and FIG. 7 is a diagram showing another example of the spatial position of a slave BMS.

Referring to FIGS. 3 and 6, the master BMS 300 may be combined to, and fixed to, one side surface of an electric part 400.

The slave BMS 210 may be located in the space between the battery modules 110 and 120. For example, the slave BMS 210 may be combined and fixed to one side surface of the two side surfaces of the battery modules 110 and 120 facing each other.

The slave BMS 220 may be located in the space between the battery modules 130 and 140. For example, the slave BMS 220 may be combined and fixed to one side surface of the two side surfaces of the battery modules 130 and 140 facing each other.

The slave BMS 230 may be located in the space between the battery modules 150 and 160. For example, the slave BMS 230 may be combined and fixed to one side surface of the two side surfaces of the battery modules 150 and 160 facing each other.

In some embodiments, the slave BMS 210 may be combined and fixed on the side surface 121 of the battery module 120 among the two side surfaces of the battery modules 110 and 120 facing each other. The slave BMS 220 may be combined and fixed on the side surface 141 of the battery module 140 among the two side surfaces of the battery modules 130 and 140 facing each other. The slave BMS 230 may be combined and fixed on the side surface 161 of the battery module 160 among the two side surfaces of the battery modules 150 and 160 facing each other.

According to one or more embodiments, the slave BMSs 210, 220, and 230 may be located at different heights with respect to the top surface or bottom surface of the battery modules 120, 140, and 160. The height of the top surfaces or bottom surfaces of the battery modules 120, 140, and 160 may be the same.

If the slave BMSs 210, 220, and 230 are located in parallel at the same height, the slave BMS 210 or the slave BMS 220 may act as an obstacle in wireless optical communication between the slave BMS 230 and the master BMS 300. In one or more embodiments, signals from the slave BMS 210 or the slave BMS 220 may act as interference. Furthermore, although there are no obstacles in wireless optical communication between the slave BMS 210 and the master BMS 300, signals from the slave BMS 220 or the slave BMS 230 may act as interference.

In one or more embodiments, as shown in FIG. 7, the battery modules 120, 140, and 160, to which the slave BMSs 210, 220, and 230 are each combined, may be located to be spatially offset from each other (e.g., may be spatially offset with respect to a vertical plane), so that there are no obstacles between each of the slave BMS 210, 220, and 230 and the master BMS 300. In this way, interference caused by signals from each other may be reduced. Such a structure may cause waste of space, and the size of the battery pack may increase.

In one or more embodiments, the slave BMS 210, 220, and 230 are located in parallel at the same height, and the position of the master BMS 300 may be adjusted. The respective spaces between the two battery modules 110 and 120, between the two battery modules 130 and 140, and between the two battery modules 150 and 160 may be relatively wide, which may also result in space waste.

To solve the above, as shown in FIG. 6, the slave BMSs 210, 220, and 230 may be located at different heights.

In one or more embodiments, the slave BMS 210 may be combined to the side surface 121 of the battery module 120 at the same height as the top surfaces of the battery module 120, 140, and 160. The slave BMS 220 may be combined to the side surface 141 of the battery module 140 at a height spaced apart from the top surfaces of the battery modules 120, 140, and 160 by a distance d1. The slave BMS 230 may be combined to the side surface 161 of the battery module 160 at a height spaced apart from the top surfaces of the battery module 120, 140, and 160 by a distance d2. The distance d1 and the distance d2 may be different. The distance d2 may be larger than the distance d1. The positions of the optical transmitters of each of the slave BMS 210, 220, and 230 may have different respective heights from a reference plane, and the positions of the optical receivers of each of the slave BMS 210, 220, and 230 may have different respective heights from the reference plane.

Because the slave BMSs 210, 220, and 230 have different height differences, other slave BMSs may not act as an obstacle in wireless optical communication between the slave BMSs 210, 220, and 230 and the master BMS 300, interference caused by signals from other slave BMS may be reduced, and space waste may also be reduced.

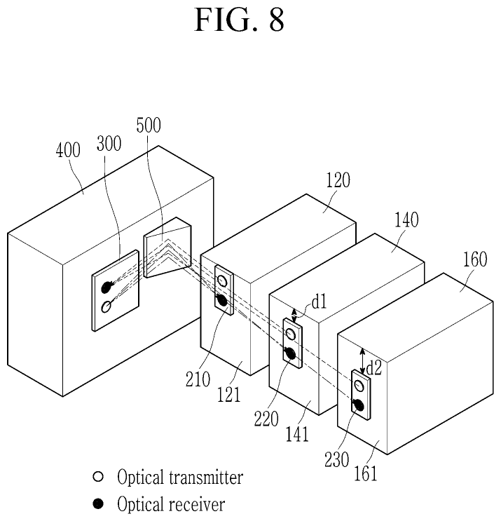

FIG. 8 is a diagram illustrating another example of the spatial position of a slave BMS in a battery pack according to one or more embodiments.

Referring to FIGS. 3 and 8, a reflector 500 may be located at the position of the master BMS 300 shown in FIG. 6. For example, a reflective film or mirror may be used as the reflector 500.

The reflector 500 may reflect signals between each of the slave BMS 210, 220, and 230 and the master BMS 300. The reflector 500 may reflect the signals received from the slave BMSs 210, 220, and 230 to the master BMS 300, and may reflect the signals received reflect the master BMS 300 to the slave BMSs 210, 220, and 230. The reflector 500 may be located at a reflection angle capable of transmitting and receiving signals between each of the slave BMS 210, 220, and 230 and the master BMS 300.

Because the slave BMSs 210, 220, and 230 may be respectively located between the two battery modules 110 and 120, between the two battery modules 130 and 140, and between the two battery modules 150 and 160, even if the slave BMSs 210, 220, and 230 have different height differences, there may be restrictions with respect to the position of the master BMS 300.

As shown in FIG. 8, if the reflector 500 location and the angle of the reflector 500 may be adjusted, freedom of disposition of the master BMS 300 may be improved without wasting spaces between the two battery modules 110 and 120, between the two battery modules 130 and 140, and between the two battery modules 150 and 160.

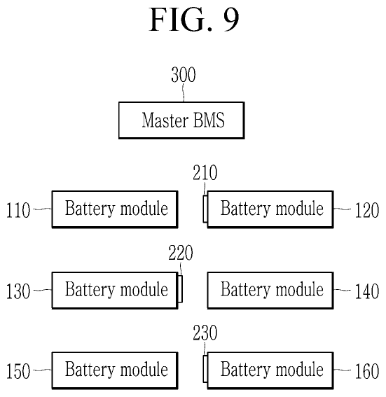

FIG. 9 is a diagram of the battery pack for explaining the placement position of the slave BMS according to one or more other embodiments. This may represent a rough floor plan.

Referring to FIG. 9, in each row, the slave BMSs 210, 220, and 230 may be not combined to the battery modules 120, 140, and 160 located in the same column, but the slave BMSs 210, 220, and 230 may be combined and fixed to the side surfaces of respective battery modules in different columns for each row.

For example, the slave BMS 210 may be fixed to the side surface of the battery module 120. The slave BMS 220 may be fixed to the side surface of the battery module 130. The slave BMS 230 may be fixed to the side surface of the battery module 160. At this time, slave BMSs that are located in the same column in different respective rows (e.g., the slave BMS 210 and the slave BMS 230) may be located at different heights from the reference plane as shown in FIG. 6.

By doing this, the slave BMSs 210, 220, and 230 may have different respective positions and/or different height differences, and other slave BMSs may not act as an obstacle in wireless optical communication between each of the slave BMS 210, 220, and 230 and the master BMS 300, such that interference caused by signals from other slave BMS may be reduced, and space waste may also be reduced.

According to at least one of the embodiments, by using wireless optical communication between the master BMS and the slave BMS, wiring complexity according to the wired communication method may be reduced and security may be strengthened compared to RF wireless communication.

According to at least one of the embodiments, signal interference between the master BMS and the slave BMS may be reduced through the disposition of the slave BMS, and communication efficiency may be increased by reducing obstacles that interfere with communication.

Although the embodiments of the present disclosure have been described in detail above, the scope of the present disclosure is not limited thereto, and various modifications and improvements of those skilled in the art using the basic concepts of the present disclosure defined in the following claims, with functional equivalents thereof to be included therein, are also included in the present disclosure.

### DESCRIPTION OF SOME OF THE REFERENCE CHARACTERS

100: Battery pack 110, 120, 130, 140, 150, 160: Battery module
210, 220, 230: Slave BMS 300: Master BMS
211, 212: AFE IC 213, 330: MCU
214, 310: Optical transmitter 215, 320: Optical receiver

What is claimed is:

1. A battery pack comprising:
battery modules arranged along rows and columns;
slave battery management systems (BMSs) respectively between adjacent ones of the battery modules in the rows of the battery modules, configured to detect status information of the adjacent ones of the battery modules, and at different respective heights; and
a master BMS configured to receive status information of the battery modules through wireless optical communication with the slave BMSs.

2. The battery pack as claimed in claim 1, wherein the slave BMSs and the master BMS each comprise:
an optical transmitter configured to transmit a wireless optical signal; and
an optical receiver configured to receive a wireless optical signal.

3. The battery pack as claimed in claim 2, wherein the optical transmitters are at different respective heights from a reference plane, and
wherein the optical receivers are at different respective heights from the reference plane.

4. The battery pack as claimed in claim 2, wherein the slave BMSs are at different respective heights with respect to uppermost or lowermost surfaces of the battery modules.

5. The battery pack as claimed in claim 2, further comprising a reflector configured to reflect a wireless optical signal from the optical transmitter of the slave BMSs to the optical receiver of the master BMS, and from the optical transmitter of the master BMS to the optical receiver of the slave BMSs.

6. The battery pack as claimed in claim 2, wherein the slave BMSs further comprise:
a first analog front end integrated circuit (AFE IC) configured to measure status information of one of the adjacent ones of the battery modules; and
a second AFE IC configured to measure status information of the other one of the adjacent ones of the battery modules.

7. The battery pack as claimed in claim 2, wherein the slave BMSs are respectively fixed to side surfaces of the adjacent ones of the battery modules facing others of the adjacent ones of the battery modules.

8. The battery pack as claimed in claim 1, further comprising a flexible printed circuit board (FPCB) connecting one of the slave BMSs to a corresponding one of the adjacent ones of the battery modules.

9. The battery pack as claimed in claim 1, wherein the wireless optical communication uses an infrared transmission medium.

10. A battery pack comprising:
battery modules arranged along rows and columns such that there are pairs of battery modules respectively in the rows;
slave battery management systems (BMSs) respectively on side surfaces of ones of the battery modules of the pairs of battery modules, the side surfaces facing others of the battery modules of the pairs of battery modules, ones of the slave BMSs in a same one of the columns being at different respective heights; and
a Master BMS configured to communicate with the slave BMSs.

11. The battery pack as claimed in claim 10, wherein the slave BMSs and the master BMS comprise:
an optical transmitter configured to transmit a wireless optical signal; and
an optical receiver configured to receive a wireless optical signal.

12. The battery pack as claimed in claim 11, wherein the slave BMSs further comprise:
a first analog front end integrated circuit (AFE IC) configured to measure status information of a first one of one of the pairs of the battery modules; and
a second AFE IC configured to measure status information of a second one of the one of the pairs of the battery modules.

13. The battery pack as claimed in claim 10, wherein the slave BMSs and the master BMS are configured to communicate using an infrared transmission medium.

14. The battery pack as claimed in claim 10, further comprising a flexible printed circuit board (FPCB) connecting one of the slave BMSs and a corresponding one of the pairs of the battery modules.

15. The battery pack as claimed in claim 10, further comprising a reflector configured to reflect a wireless optical signal from the slave BMSs to the master BMS, and configured to reflect a wireless optical signal from the master BMS to the slave BMSs.
